(19) United States
(12) Patent Application Publication
(10) Pub. No.: US 2015/0056488 A1
(43) Pub. Date: Feb. 26, 2015

(54) POLYMER ELECTROLYTES FOR DENDRITE-FREE ENERGY STORAGE DEVICES HAVING HIGH COULOMBIC EFFICIENCY

(71) Applicant: Battelle Memorial Institute, Richland, WA (US)

(72) Inventors: Ji-Guang Zhang, Richland, WA (US); Wu Xu, Richland, WA (US); Xilin Chen, Richland, WA (US); Jiulin Wang, Shanghai (CN); Yaohui Zhang, Harbin (CN); Jianfeng Qian, Richland, WA (US)

(73) Assignee: BATTELLE MEMORIAL INSTITUTE, Richland, WA (US)

(21) Appl. No.: 14/337,041

(22) Filed: Jul. 21, 2014

Related U.S. Application Data
(60) Provisional application No. 61/856,932, filed on Jul. 22, 2013.

(51) Int. Cl. H01M 10/0565; H01M 10/0525

(52) U.S. Cl. CPC H01M 10/0565; H01M 10/0525; H01M 2300/0085; H01M 2300/0082
USPC 429/126; 429/306; 429/314; 429/317; 429/312; 429/309; 429/303

(57) ABSTRACT

The Coulombic efficiency of metal deposition/stripping can be improved while also preventing dendrite formation and growth by an improved electrolyte composition. The electrolyte composition also reduces the risk of flammability. The electrolyte composition includes a polymer and/or additives to form high quality SEI layers on the anode surface and to prevent further reactions between metal and electrolyte components. The electrolyte composition further includes additives to suppress dendrite growth during charge/discharge processes. The electrolyte composition can also be applied to lithium and other kinds of energy storage devices.

### CROSS REFERENCE TO RELATED APPLICATION

This application claims the benefit of U.S. Provisional Patent Application No. 61/856,932, filed Jul. 22, 2013, which is hereby incorporated by reference.

### ACKNOWLEDGMENT OF GOVERNMENT SUPPORT

This invention was made with government support under Contract DE-AC0576RLO1830 awarded by the U.S. Department of Energy. The government has certain rights in the invention.

### BACKGROUND

With the increasing demand, the escalating supply issues, the higher prices, and the environmental concerns associated with fossil fuels, electrical-energy generating devices and energy storage devices (e.g., fuel cells, batteries, and capacitors) with substantially higher energy and power densities and faster recharge times are urgently needed in almost all applications, including, mobile, transportation, and grid applications. The state-of-the-art batteries, including lithium-ion batteries, for mobile electronic devices in the present commercial market cannot meet the requirements. Lithium metal batteries are very attractive due to the use of high capacity lithium metal as anodes. However, even the use of most polymer electrolytes still cannot prevent the lithium dendrite penetration through the polymer electrolytes. Thus, solving or reducing the safety problem of dendrite formation, of battery cyclability and safety, and of low Coulombic efficiency of metal deposition will enable the practical use of rechargeable metal polymer batteries and accelerate the commercialization of high-energy and high-power metal-ion and metal batteries for commercial applications, including commercial electronics, electrical vehicles, and grid energy storages.

Therefore, a need for improved dendrite-free metal polymer energy storage devices with high Coulombic efficiency and/or fewer safety hazards exists.

### SUMMARY

Disclosed herein is an energy storage device comprising an anode and a first metal (M1) electrodeposited on the anode during operation of the device, the energy storage device characterized by an electrolyte composition comprising a polymer, cations of M1 and by a surface-smoothing additive comprising a metal (M2), cations of M2 having an effective electrochemical reduction potential in solution or in polymer lower than that of the cations of M1.

Also disclosed herein is an energy storage device comprising an anode and lithium metal electrodeposited on the anode during operation of the device, the energy storage device characterized by an electrolyte composition comprising a polymer, lithium cations and a surface-smoothing additive comprising a metal (M2), cations of M2 having a concentration in solution less than 30% of that of the lithium cations and having an effective electrochemical reduction potential in solution lower than that of the lithium cations.

Further disclosed herein is an electrolyte composition for enhancing surface smoothness during electrodeposition of a metal (M1) on an anode that occurs when operating an energy storage device, the electrolyte composition characterized by a polymer, cations of M1 and by a surface-smoothing additive comprising a metal (M2), cations of M2 having an effective electrochemical reduction potential in solution or polymer lower than that of the cations of M1.

The foregoing will become more apparent from the following detailed description, which proceeds with reference to the accompanying figures.

### BRIEF DESCRIPTION OF THE DRAWINGS

FIG. 1 represents the internal structure of a battery as disclosed herein.

FIGS. 2A and 2B are graphs depicting lithium deposition and stripping profiles of Li symmetric cells without surface-smoothing additives.

FIGS. 3A and 3B are graphs depicting lithium deposition and stripping profiles of Li symmetric cells having a surface-smoothing additive at a weight ratio of Cs salt/Li salt=1:10 according to embodiments of the present invention.

FIGS. 4A and 4B are graphs depicting lithium deposition and stripping profiles of Li symmetric cells having a surface-smoothing additive at a weight ratio of Cs salt/Li salt=1:5 according to embodiments of the present invention.

### DETAILED DESCRIPTION

This invention describes polymer electrolyte compositions, which can suppress dendrite growth, retain high Coulombic efficiency of metal deposition/stripping, and/or reduce device flammability. The electrolyte composition comprises a mixture of appropriate polymers or by adding appropriate SEI formation additives to form high quality SEI layers on the metal anode surface and to limit reactions between the metal and the electrolyte constituents. The electrolyte composition further comprises self-healing electrostatic shield (SHES) additives to prevent dendrite formation and growth on the metal or graphite anodes during long-term charge/discharge processes and other extreme charging conditions.

The SHES mechanism is illustrated in U.S. Application Publication US 2013/0202956 A1 and in Journal of the American Chemical Society, 2013, 135(11), pp4450-4456, both of which are incorporated herein by reference. In general, M1 cations can be any cations that have an effective electrochemical reduction potential less than those of selected M2 cations, which SHES additives comprise. In one embodiment, the M₁ cation comprises lithium cations (e.g., Li⁺) and the SHES additive can comprise an additive metal (M₂) salt containing M₂ cations that are not substantially reactive with anodes and cathode through intercalation, alloying, or conversion reactions. The M₂ cations of the additive salt can be preferentially adsorbed, but cannot be deposited on the protruded region of the lithium anode surface and, can form a positively charged SHES layer that covers the protruded region. During the charging process, the Li⁺ ions will be prevented from depositing in the protruded region of the anode by the SHES effect; instead, they will be preferentially deposited onto the non-protruded region. This self-smoothing process will effectively improve the smoothness of the deposited lithium film. In addition, by choosing appropriate polymers and/or additives for forming good solid electrolyte interphase (SEI) layers, and by optimizing the electrolyte formulations, high Coulombic efficiency of lithium metal deposition/stripping can be achieved. Thus practical rechargeable lithium metal batteries with significantly improved safety and long-term cycle life can be realized.

SHES additive salts can comprise M₂ cations that include, but are not limited to Cs, Rb, K, Ba, Sr, Ca, Li, Na, Mg, Al, La, and Eu. The preferred cation is Cs. The salts can comprise anions that include, but are not limited to PF₆⁻, AsF₆⁻, BF₄⁻, AlF₄⁻, N(SO₂CF₃)₂⁻ (TFSI⁻), N(SO₂F)₂⁻ (FSI⁻), CF₃SO₃⁻ (TO , ClO₄⁻, bis(oxalate)borate (BOB⁻), difluoro oxalato borate (DFOB⁻), F⁻, Cl⁻, Br⁻, I⁻, and combinations thereof.

The selected polymer electrolytes have much less side reaction in contact with Li metal and can significantly diminish the flammability problem common to lithium energy storage devices. Examples of appropriate polymers include, but are not limited to, hexafluopropylene (PVdF-co-HFP), polyethylene glycol (PEG), polyethylene oxide (PEO), poly(methyl methacrylate) (PMMA), poly(acrylonitrile) (PAN), copolymers such as poly(ethylene oxide-propylene oxide) (PEO-co-PPO), vinylidene fluoride and hexafluopropylene (PVdF-co-HFP), and block copolymers such as poly(methyl methacrylate)-b-poly(oligo(oxyethylene) methacrylate) (PMMA-b-POEM), poly(ethylene oxide) and polystyrene (PS) (PEO-b-PS). The electrolyte composition can alternatively comprise gel polymers. Examples of gel polymers include, but are not limited to, combinations of liquid electrolytes and polymers, copolymers, or block polymers. In certain embodiments, the gel polymer has a liquid electrolyte solution soaked in a material selected from the group consisting of polyethylene glycol (PEG), polyethylene oxide (PEO), poly(methyl methacrylate) (PMMA), poly(acrylonitrile) (PAN), copolymers, block copolymers, and combinations thereof. “Soaked” means that the liquid electrolyte is confined inside the polymer, and the liquid does not flow freely thus avoiding leakage of the liquid electrolyte. The solvent and solute of the liquid electrolyte are described, for example, in US 2013/0202956 A1, which is incorporated herein by reference. Further still, the addition of SEI formation additives can help to form high quality SEI layers on the lithium anode surface. Examples of SEI formation additives include, but are not limited to vinylene carbonate, fluoroethylene carbonate, vinyl ethylene carbonate, 4-methylene ethylene carbonate, water, and combinations thereof. In certain embodiments the SEI formation additive is water.

The preferable amount of polymer is 5-95% by weight, more preferably 20-80 wt%, and most preferably 40-70 wt%, based on the total weight of the electrolyte composition. The preferable amount of M1 salt is 5-50 wt%, more preferably 10-40 wt%, and most preferably 15-30 wt%, based on the total weight of the electrolyte composition. The SHES additive is preferably 1-30 wt%, more preferably 2-20 wt%, and most preferably 3-10 wt%, based on the total weight of the electrolyte composition. The SEI formation additive (except for water) is preferably 1-20 wt%, more preferably 2-15 wt%, and most preferably 3-10 wt%, based on the total weight of the electrolyte composition.

In the case where water is used as the SEI formation additive, the water amount is up to 100 ppm in the electrolyte composition.

The electrolyte composition may also include an aprotic solvent. Illustrative aprotic solvents include carbonates, carboxylates, ethers, lactones, sulfones, phosphates, phosphites, nitriles, and combinations thereof.

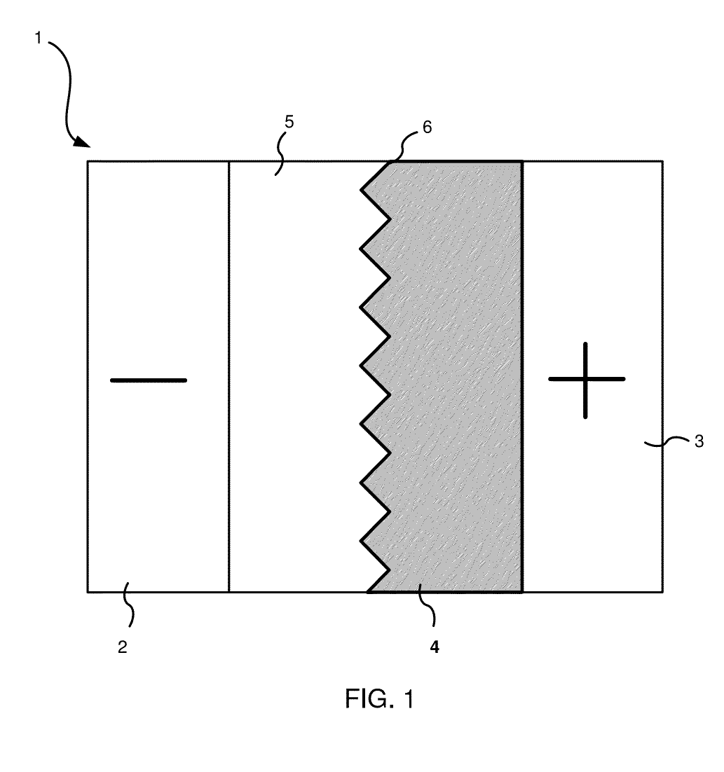

FIG. 1 represents an embodiment of a battery disclosed herein. The battery 1 includes an anode 2, a cathode 3, and a polymer electrolyte 4 interposed between the anode 2 and cathode 3. The anode 2 may be made from M1 metal or other conductive substrates. The cathode 3 may contain M1⁺ cations arranged in a lattice structure. The polymer electrolyte 4 may contain the components described above. M1 metal 5 is deposited on the anode during operation of the battery.

Protrusions or dendrites 6 of M1 will form, but they will be smoothed as described above.

For use as a control sample, 0.8 g PEO (Mw, 160,000) and 0.3 g LiTFSI were mixed in 25 ml acetonitrile. No surface-smoothing additive was used. After dissolution, the homogeneous solution was poured into a PTFE disk. The solvent acetonitrile was vaporized overnight at room temperature, followed by vacuum drying at 110° C., resulting in a thin polymer electrolyte film with thickness approximately equal to 200 μm. The Li salt concentration was 27.3% by weight, or [Li⁺]/[EO]=1/17.3 by molar ratio where EO is the repeating ethyleneoxy unit in PEO. All processes were carried out in a glove box filled with purified argon and with a moisture and oxygen content less than 1 ppm.

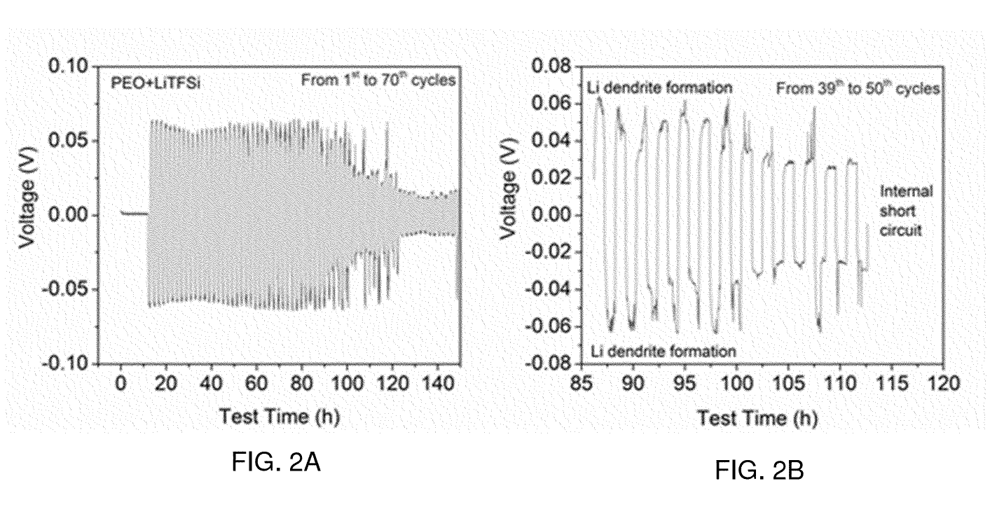

Li symmetric cells were assembled in an argon-filled glove box and Li deposition and stripping were measured at 80° C. with current density of 0.5 mA/cm². The time for each deposition or stripping process was 1 hour and the voltage versus time was measured. FIGS. 2A and 2B show the lithium deposition and stripping profiles of these Li symmetric cells. The cycling was stable for about 39 cycles. After approximately 39 cycles, lithium dendrites formed. After the 46^{th} cycle, internal short circuiting occurred and the polarization voltage dropped quickly from about 60 mV to about 30 mV.

In a first embodiment, 0.8g PEO (Mw, 160,000) and 0.3g LiTFSI and 0.03g CsTFSI was mixed in 25 ml acetonitrile. After dissolution, the homogeneous solution was poured into a PTFE disk. The solvent acetonitrile was vaporized overnight at room temperature, followed by vacuum drying at 110° C., resulting in a thin polymer electrolyte film with thickness approximately equal to 200 pm. The Li salt concentration was 26.5% by weight and Cs salt concentration was 2.7% by weight, or [Li⁺]/[EO]=1/17.3 by molar ratio where EO is the repeating ethyleneoxy unit in PEO and the weight ratio of Cs salt and Li salt was 1:10. All processes were carried out in a glove box filled with purified argon and with a moisture and oxygen content less than 1 ppm.

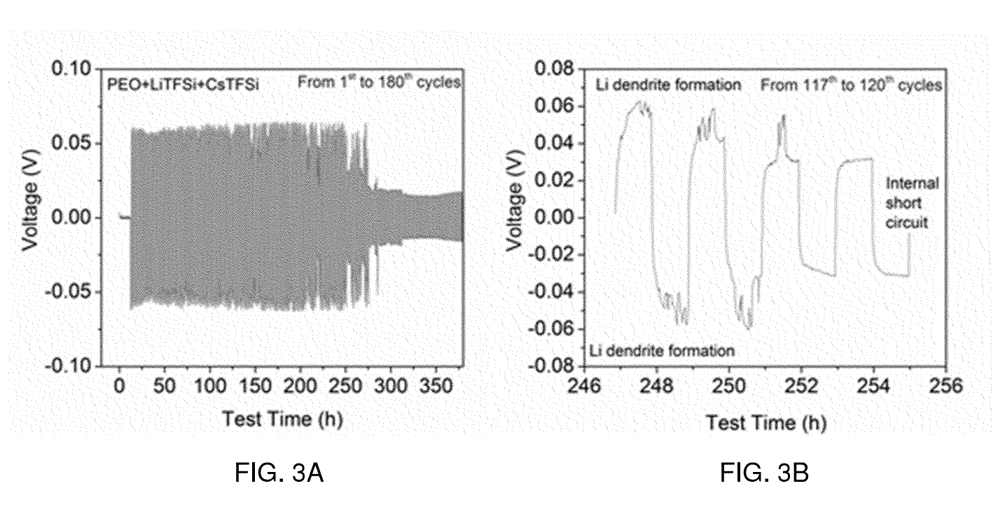

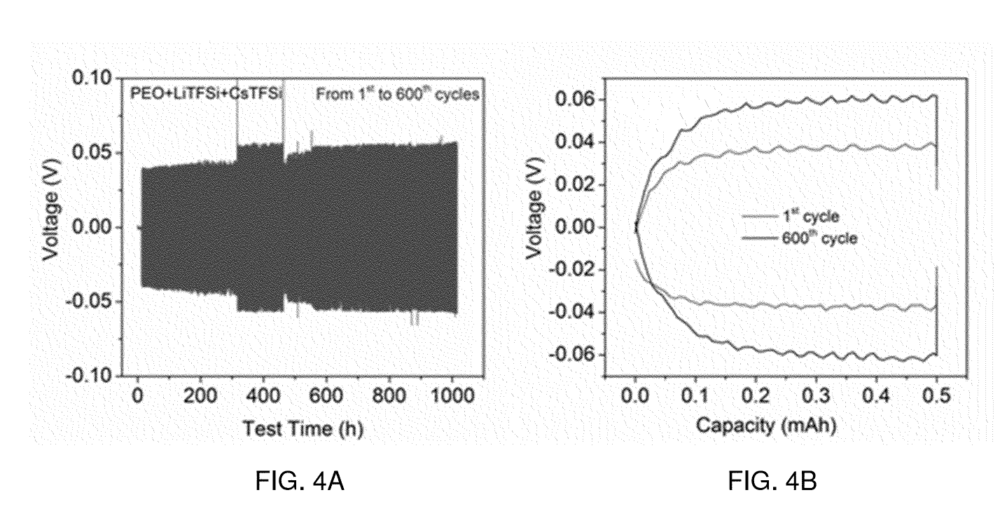

Li symmetric cells were assembled in an argon-filled glove box and lithium deposition and stripping were conducted at 80° C. with current density of 0.5 mA/cm². The time for each deposition or stripping was 1 hour and the voltage versus time was measured. FIGS. 3A and 3B show the lithium deposition and stripping profiles of these lithium symmetric cells. The cycling was stable for about 117 cycles. Only after approximately 117 cycles, did lithium dendrites form and cause internal short circuiting at the 120^{th} cycle. The polarization voltage dropped quickly from about 60 mV to about 30 mV. It is demonstrated that 10% by weight of Cs salt additive of Li salt in the polymer electrolyte can greatly postpone the lithium dendrite formation and extend the cycle life before internal short circuiting occurs. In another embodiment, 0.8 g PEO (Mw, 160,000) and 0.3 g LiTFSI and 0.06 g CsTFSI was mixed in 25 ml acetonitrile. After dissolution, the homogeneous solution was poured into a PTFE disk. The solvent acetonitrile was vaporized overnight at room temperature, followed by vacuum drying at 110° C., resulting in a thin polymer electrolyte film with thickness approximately equal to 200 μm. The Li salt concentration was 25.9% by weight and Cs salt concentration was 5.2% by weight, or [Li⁺]/[EO]=1/17.3 by molar ratio where EO is the repeating ethyleneoxy unit in PEO and the weight ratio of Cs salt and Li salt was 1:5. All processes were carried out in a glove box filled with purified argon. Li symmetric cells were assembled in an argon-filed glove box and lithium deposition and stripping were conducted at 80° C. with current density of 0.5 mA/cm². The time for each deposition or stripping process was 1 hour and the voltage versus time was measured. FIGS. 4A and 4B show the lithium deposition and stripping profiles of these lithium symmetric cells. Even after approximately 600 cycles, no internal short circuit was demonstrated although the polarization voltage varied between 40 mV and about 56 mV during the cycling test and slightly increased from 40 mV at the beginning to about 65 mV at the end of this test. The possible reason is the variation and increase of cell internal resistance. The spikes in the voltage vs. time shown in FIGS. 4A and 4B is the result of transient temperature drop when the oven door was opened during long-term testing. It is demonstrated that 20% by weight of Cs-salt additive of Li salt in the polymer electrolyte can significantly suppress the lithium dendrite formation and then extend the long-term cycle life before internal short circuiting occurs.

Compared to liquid electrolytes, polymer electrolytes can be thermodynamically more stable with fresh lithium according to embodiments described herein. In other words, during lithium deposition and stripping, a liquid electrolyte such as ethylene carbonate (EC), propylene carbonate (PC), dimethyl carbonate (DMC), ethyl methyl carbonate (EMC), or diethyl carbonate (DEC) can react with fresh lithium to form an SEI (solid electrolyte interface) that consumes both liquid electrolyte and lithium metal, leading to relatively low Coulombic efficiency. In contrast, polymers such as PEO can be stable with fresh lithium. There is little or no interfacial reaction during lithium deposition and stripping. Therefore, lithium dendrite-free deposition with high Coulombic efficiency (which are basic requirements for long-cycle-life battery using lithium metal as anodes) can be obtained from polymer electrolyte containing M2 additive, as described herein, to effectively suppress lithium dendrite formation and growth.

The purpose of the foregoing description is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth are to be regarded as illustrative in nature, and not as restrictive.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. An energy storage device comprising an anode and a first metal (M1) electrodeposited on the anode during operation of the device, the energy storage device characterized by an electrolyte composition comprising a polymer, cations of M1 and by a surface-smoothing additive comprising a metal (M2), cations of M2 having an effective electrochemical reduction potential in solution or in polymer lower than that of the cations of M1.

2. The device of claim 1, wherein the anode comprises carbon.

3. The device of claim 1, wherein the anode comprises lithium metal.

4. The device of claim 1, wherein the anode comprises silicon, silicon oxide, tin, tin oxide, antimony, sodium, magnesium, or combinations thereof.

5. The device of claim 4, wherein the anode further comprises carbonaceous material or a combination of carbonaceous material and lithium powder.

6. The device of claim 1, wherein the surface-smoothing additive comprises an anion selected from the group consisting of PF₆⁻, TFSI⁻, AsF₆⁻, ClO₄⁻, bis(oxalate)borate (BOB⁻), and combinations thereof.

7. The device of claim 1, wherein the surface-smoothing additive comprises an anion selected from the group consisting of PF₆⁻, AsF₆⁻, ClO₄⁻, bis(oxalate)borate (BOW), BF₄⁻, AlF₄⁻, N(SO₂CF₃)₂⁻ (TFSI⁻), N(SO₂F)₂⁻ (FSI⁻), CF₃SO₃⁻ (Tf⁻) , difluoro oxalato borate (DFOB⁻), F⁻, Cl⁻, Br⁻, I⁻, and combinations thereof.

8. The device of claim 1, wherein the electrolyte composition further comprises a solid electrolyte interphase formation additive selected from the group consisting of vinylene carbonate, fluoroethylene carbonate, vinyl ethylene carbonate, 4-methylene ethylene carbonate, water, and combinations thereof.

9. The device of claim 1, wherein M1 comprises Li.

10. The device of claim 1, wherein M2 comprises a metal selected from the group consisting of Cs, Rb, K, Ba, Sr, Ca, Li, Na, Mg, Al, La, Eu and combinations thereof.

11. The device of claim 1, wherein the cations of M2 have an activity in solution or in polymer such that the effective electrochemical reduction potential of M2 is lower than that of the cation of M1.

12. The device of claim 1, wherein the cations of M2 have a concentration in the electrolyte composition that is 0.1-50% by weight of that of the cations of M1.

13. The device of claim 1, wherein the cations of M2 have a concentration in the electrolyte composition that is 5-30% by weight of that of the cations of M1.

14. The device of claim 1, wherein the cations of M2 are not electrochemically nor chemically reactive with respect to M1 or the cations associated with M1.

15. The device of claim 1, having an applied voltage less than, or equal to that of the electrochemical reduction potential of the cations of M1 and greater than the effective electrochemical reduction potential of the cations of M2 during the M1 deposition process.

16. The device of claim 1, further comprising a cathode comprising Li₄₋ₓMₓTi₅O₁₂ (M=Mg, Al, Ba, Sr, or Ta; 0≦x ≦1), MnO₂, V₂O₅, V₆O₁₃, LiV₃O₈, LiM^{C1}ₓM^{C2}₁₋ₓPO₄ (M^{C1} or M^{C2}=Fe, Mn, Ni, Co, Cr, or Ti; 0≦x ≦1), Li₃V₂₋ₓ(PO₄)₃ (M=Cr, Co, Fe, Mg, Y, Ti, Nb, or Ce; 0≦x≦1), LiVPO₄F, LiM^{C1}ₓM^{C2}₁₋ₓO₂ ((M^{C1} or M^{C2}=Fe, Mn, Ni, Co, Cr, Ti, Mg, Al; 0≦x≦1), LiM^{C1}ₓM^{C2}_{y}M^{C3}_{1-x-y}O₂ ((M^{C1}, M^{C2}, or M^{C3}=Fe, Mn, Ni, Co, Cr, Ti, Mg, or Al; 0≦x≦1; 0≦y≦1), LiMn_{2-y}X_{y}O₄ (X=Cr, Al, or Fe, 0≦y≦1), LiNi_{0.5-y}X_{y}Mn_{1.5}O₄ (X=Fe, Cr, Zn, Al, Mg, Ga, V, or Cu; 0≦y≦0.5), xLi₂MnO₃·(1−x)LiM^{C1}_{y}M^{C2}_{z}M^{C3}_{1-y-x}O₂ (M^{C1}, M^{C2}, or M^{C3}=Mn, Ni, Co, Cr, Fe, or mixture of; x=0.3-0.5; y≦0.5; z≦0.5), Li₂MSiO₄ (M=Mn, Fe, or Co), Li₂MSO₄ (M=Mn, Fe, or Co), LiMSO₄F (Fe, Mn, or Co), Li₂₋ₓ(Fe_{1-y}Mn_{y})P₂O₇ (0≦y≦1), Cr₃O₈, Cr₂O₅.

17. The device of claim 1, wherein the polymer comprises a material selected from the group consisting of polyethylene glycol (PEG), polyethylene oxide (PEO), poly(methyl methacrylate) (PMMA), poly(acrylonitrile) (PAN), copolymers, block copolymers, and combinations thereof.

18. The device of claim 17, wherein the copolymer is selected from the group consisting of poly(ethylene oxide-propylene oxide) (PEO-co-PPO), vinylidene fluoride, hexafluopropylene (PVdF-co-HFP), and combinations thereof.

19. The device of claim 17, wherein the block copolymer is selected from the group consisting of poly(methyl methacrylate)-b-poly(oligo(oxyethylene) methacrylate) (PMMA-b-POEM), poly(ethylene oxide)-b-polystyrene (PS) (PEO-b-PS), and combinations thereof.

20. The device of claim 1, wherein the polymer comprises a gel polymer having a liquid electrolyte solution soaked in a material selected from the group consisting of polyethylene glycol (PEG), polyethylene oxide (PEO), poly(methyl methacrylate) (PMMA), poly(acrylonitrile) (PAN), copolymers, block copolymers, and combinations thereof.

21. The device of claim 20, wherein the liquid electrolyte is present in an amount of 1 to 90 wt%, based on the total weight of the liquid electrolyte and the polymer.

22. The device of claim 8, wherein the solid electrolyte interphase formation additive is water, and the water is present in an amount of up to 100 ppm in the electrolyte composition.

23. The device of claim 1, wherein M2 comprises Cs.

24. The device of claim 9, wherein the surface-smoothing additive comprises an anion selected from the group consisting of PF₆⁻, AsF₆⁻, ClO₄⁻, bis(oxalate)borate (BOB⁻), BF₄⁻, AlF₄⁻, N(SO₂CF₃)₂⁻ (TFSI⁻), N(SO₂F)₂⁻ (FSI⁻), CF₃SO₃⁻ (Tf⁻, difluoro oxalato borate (DFOB⁻), F⁻, Cl⁻, Br⁻, I⁻, and combinations thereof; M2 comprises Cs; and the polymer comprises a material selected from the group consisting of polyethylene glycol (PEG), polyethylene oxide (PEO), poly(methyl methacrylate) (PMMA), poly(acrylonitrile) (PAN), copolymers, block copolymers, and combinations thereof.

25. An energy storage device comprising an anode and lithium metal electrodeposited on the anode during operation of the device, the energy storage device characterized by an electrolyte composition comprising a polymer, lithium cations and a surface-smoothing additive comprising a metal (M2), cations of M2 having a concentration in solution less than 30% of that of the lithium cations and having an effective electrochemical reduction potential in solution lower than that of the lithium cations.

26. The device of claim 25, wherein the surface-smoothing additive comprises an anion selected from the group consisting of PF₆⁻, TFSI⁻, AsF₆⁻, ClO₄⁻, bis(oxalate)borate (BOB⁻), and combinations thereof.

27. The device of claim 25, wherein the surface-smoothing additive comprises an anion selected from the group consisting of PF₆⁻, AsF₆⁻, ClO₄⁻, bis(oxalate)borate (BOB⁻), BF₄⁻, AlF₄⁻, N(SO₂CF₃)₂⁻ (TFSI⁻), N(SO₂F)₂⁻ (FSI⁻), CF₃SO₃⁻ (Tf⁻, difluoro oxalato borate (DFOB⁻), F⁻, Cl⁻, Br⁻, I⁻, and combinations thereof.

28. The device of claim 25 wherein M2 comprises a metal selected from the group consisting of cesium, rubidium, potassium, strontium, barium, and combinations thereof.

29. The device of claim 25, wherein the anode comprises lithium metal.

30. The device of claim 25, wherein the anode comprises carbon.

31. The device of claim 25, wherein the anode comprises silicon, silicon oxide, tin, tin oxide, antimony, sodium, magnesium, or combinations thereof

32. The device of claim 31, wherein the anode further comprises carbonaceous material or a combination of carbonaceous material and lithium powder.

33. The device of claim 25, having a separator between the anode and the cathode.

34. The device of claim 25, having an applied voltage less than, or equal to, that of the electrochemical reduction potential of the lithium cations and greater than the effective electrochemical reduction potential of the cations of M2 during lithium deposition process.

35. The device of claim 25, wherein the polymer comprises a material selected from the group consisting of polyethylene glycol (PEG), polyethylene oxide (PEO), poly(methyl methacrylate) (PMMA), poly(acrylonitrile) (PAN), copolymers, block copolymers, and combinations thereof.

36. The device of claim 35, wherein the copolymer is selected from the group consisting of poly(ethylene oxide-propylene oxide) (PEO-co-PPO), vinylidene fluoride, hexafluopropylene (PVdF-co-HFP), and combinations thereof.

37. The device of claim 35, wherein the block copolymer is selected from the group consisting of poly(methyl methacrylate)-b-poly(oligo(oxyethylene) methacrylate) (PMMA-b-POEM), poly(ethylene oxide)-b- polystyrene (PS) (PEO-b-PS), and combinations thereof.

38. The device of claim 25, wherein the electrolyte composition further comprises a solid electrolyte interphase formation additive selected from the group consisting of vinylene carbonate, fluoroethylene carbonate, vinyl ethylene carbonate, 4-methylene ethylene carbonate, water, and combinations thereof.

39. An electrolyte composition for enhancing surface smoothness during electrodeposition of a metal (M1) on an anode that occurs when operating an energy storage device, the electrolyte composition characterized by a polymer, cations of M1 and by a surface-smoothing additive comprising a metal (M2), cations of M2 having an effective electrochemical reduction potential in solution or polymer lower than that of the cations of M1.

40. The electrolyte composition of claim 39, wherein the additive comprises an anion selected from the group consisting of PF₆⁻, TFSI⁻, AsF₆⁻, ClO₄⁻, bis(oxalate)borate (BOB⁻), and combinations thereof.

41. The electrolyte composition of claim 39, wherein the surface-smoothing additive comprises an anion selected from the group consisting of PF₆⁻, AsF₆⁻, ClO₄⁻, bis(oxalate)borate (BOB⁻), BF₄⁻, AlF₄⁻, N(SO₂CF₃)₂⁻ (TFSI⁻), N(SO²F)₂⁻ (FSI⁻), CF₃SO₃⁻(Tf⁻, difluoro oxalato borate (DFOB⁻), F⁻, Cl⁻, Br⁻, I⁻, and combinations thereof.

42. The electrolyte composition of claim 39, wherein M1 comprises Li.

43. The electrolyte composition of claim 39, wherein M2 comprises a metal selected from the group consisting of Cs, Rb, K, Ba, Sr, Ca, Li, Na, Mg, Al, La, Eu and combinations thereof.

44. The electrolyte composition of claim 39, wherein the cations of M2 have an activity in solution or polymer such that the effective electrochemical reduction potential of M2 is lower than that of the cation of M1.

45. The electrolyte composition of claim 39, wherein the concentration of the cations of M2 is 1-50%, by weight of that of the cations of M1.

46. The electrolyte composition of claim 39, wherein the concentration of the cations of M2 is 5-30% by weight of that of the cations of M1.

47. The electrolyte composition of claim 39, wherein the cations of M2 are not electrochemically nor chemically reactive with respect to M1 or the cations associated with M1.

48. The electrolyte composition of claim 39, wherein the electrolyte composition is a solution that comprises an aprotic solvent selected from the group consisting of carbonates, carboxylates, ethers, lactones, sulfones, phosphates, phosphites, nitriles, and combinations thereof.
